(19) United States
(12) Patent Application Publication
(10) Pub. No.: US 2007/0255728 A1
(43) Pub. Date: Nov. 1, 2007

(54) Apparatus and Process for Distributed Autonomous Managing of Documents and Electronic Means

(76) Inventors: Valerio Abate, Saronno (Varese) (IT); Alberto Conti, Milano (IT); Bianchi Michela, Milano (IT)

Correspondence Address: DICKSTEIN SHAPIRO LLP, 1825 EYE STREET NW, Washington, DC, 20006-5403, US

(21) Appl. No.: 10/579,035

(22) PCT Filed: Nov. 10, 2003
(86) PCT No.: PCT/IT03/00727

§ 371 Date: May 1, 2007

(51) Int. Cl. G06F 17/30

(52) U.S. Cl. 707/100; 707/E17.008

(57) ABSTRACT

According to the preferred embodiments of the present invention, an apparatus and method for distributed storing and retrieving of paper documents and their electronic means is disclosed. In this context, storing of documents refers to the efficient management of storage and document retrieval based not only on image but also on document contents means such as words, concepts, numbers etc. The preferred embodiments of the present invention provide for easy and effective indexing, storing, retrieving, searching and managing of paper-based documents and their contents. The proposed apparatus and method implement a desktop solution for filing which can be made available to each worker. Uniquely, the digital means filing system of the present invention allows user to index and label documents whenever desired prior of storing original in a file box which includes a memory device able to contain documents means such as image and contents in electronic format. Labeling of documents and file box by using either a dedicated desktop radio frequency identifier tag or printed labels. Operation of storing of documents in file box by using either a dedicated desktop radio frequency identifier tag or printed label to check and list contents. The most preferred embodiments of the present invention utilizes flash memory type unit and individual radio frequency identifier tags that are attached to the document and to the box and programmed once the filing procedure is successful. In an other preferred embodiment of the present invention the file box has memory module including a wireless communication device such as a blue-tooth able to internally check the presence of all memorized documents.

### BACKGROUND OF THE INVENTION

1. Field of the Invention

The present invention relates to an apparatus and method for managing documents such as storage, checking, search and retrieval of documentary information, primarily original papers their contents and images.

2. The Prior Art

Numerous systems and processes have been proposed for the storage and retrieval of documentary information. Traditional practices over the centuries, of course, have involved storage and retrieval by manually accessing indexed arrangements of original papers and “hard copies” in folders, boxes, shelving and cabinets. Later practices have involved photographically reducing the original papers to produce indexed miniaturizations in microfilm spools or microfiche sheets, storing the spools or sheets in indexed containers or files, and retrieving images or hard copies of the miniaturizations by optical projection or photographic reproduction.

Now there are a proliferation of proposals for digital computer systems that opto-electronically scan original papers to create electronic representations in computer memory, to store digital records of these representations in magnetic and/or optical media, and to retrieve images or hard copies corresponding to these records electro magnetically or electro optically. It is common experience magnetically or electro optically. It is common experience that effective paper filing systems have required unerring care by trustworthy persons who have some understanding of the business or other activity involved. Considerable reliance has been placed on the memory of such persons, who have a tendency to become “indispensable” in mission critical situations. Moreover, even a generally effective system often is not conducive to physical and logical arrangements capable of implementing prompt storage and retrieval without constant inquiries to and guidance by professional level personnel. Finally, of course, a paper file is available to only one person at a time.

Although a few, but not all, of these problems are alleviated by the use of microfilm and microfiche, new and different problems arise. It is true that a large number of photographic miniaturizations can be stored in a much smaller space than an equivalent number of original papers. However, problems of storing and retrieving containers and folders of microfilm and microfiche are not unlike problems of storing and retrieving batches of their paper counterparts. More important, producing and imaging photographic miniaturizations are costly procedures requiring unwieldy hardware. As a practical matter, microfilm and microfiche are limited to archival-type documentation that may not be compatible with a dynamic work environment.

Recent advances in low cost computer architecture, particularly, faster clock speeds, higher resolution displays, and denser storage media, have generated discussions of whether or not a “paperless office” is possible, and, indeed, what is the meaning of “paperless office. The difficulties mentioned above in connection with the storage and retrieval of paper, in a work environment, make it clear that minimization of the use of paper must be a pre-eminent commercial and technological objective. A critical advantage of electronic imaging over paper files and microfilm/microfiche is that electronic images can be sorted, retrieved and reorganized, readily. Electronic imaging has obviated tedious manipulation of paper files where there may be no further need ever to refer to the original papers.

More recent advances in image manipulation and electronic document analysis such as OCR (optical character recognition) and semantic engines allowed extracting content s from the document such as simple words or more complex semantic significance like acronyms, dates, numbers and tables. Due to the evolution of database architecture and to the improvement of memory storage these semantic data, along with standard field such as date, title, doc. Number etc. permit efficient document retrieval based on contents and thus they are reducing once more the dependence on critical resources and professional level people even in the case of identify the document according to contained topics.

The problem of original document preservation and guaranteeing security is still based on human surveillance on individual people accesses and on paper visual checking. If some hidden manipulation or movement is performed, the disappearing of documents could never discovered until the need of consulting it. Often document disappears during movement from one location to the other inside storage building or from building to building transfer when they are transferred in quantities. It is not frequent but mandatory to transfer original documents.

For example, original documents may be required or merely useful (1) in litigation where the rules of evidence pertain, (2) as backup in the event that lost or faulty images are discovered later, (3) in financial and insurance institutions where validation of original signatures may be needed, (4) as backup for technical drawings where differences in resolution between images and originals may become significant, and (5) as complete copies of voluminous treatises in which only selected portions have been imaged.

Much confusion has been encountered in the implementation of systems that are based on electronic imaging and original paper backup. The following are some of the conflicts involved: whether to store bit maps based on simple scanning, or text resulting from optical character recognition, or both; whether to mix locally generated text documents (which are unsigned or otherwise unauthenticated) and locally scanned images (which may be signed or otherwise authenticated); whether or not the imaging system should mirror the original paper system; whether or not an original paper system should be retained without change; whether or not the system is so sophisticated that computer literate professional level operators and/or supervisors are required; whether or not the system is so rudimentary that even entry level operators may be sufficiently trustworthy; whether or not to transfer documents to same central store or to preserve in several regional stores; and whether or not to modify the standard storing processes or to adapt the storage system to the company structure.

A further problem arise in labelling for optical reading or electromagnetic reading requires a close proximity device for optical and an accuracy in ray projection to be read and identified. It requires a relative high intensity and distribution of field if of electromagnetic type.

An other further problem is related to the disposition of boxes, envelopes or in general documents requires enclosures organized with special furniture and frames increasing costs and requiring big managing efforts to move documents and containers.

An other further problem of efficiency is the localization of document position is related to an external reference and in case of error a document or a document file box could be easily lost or in the best case requires time to be researched.

An other further problem is related to important documents to be stored in safe places which contents should be guaranteed sealed envelopes or boxes are used. The system does not guarantee and certify that the envelope is places in the place with enough temporal discretion, let say every few seconds and that the envelope is always closed and integral between one check and the other.

Documents search is not possible at the level of moving and requires explicit operations of maintenance or updating when moved thus being a source of errors or mistakes

Pursuant to the present invention, newly received or generated physical documents are stored in a FIFO way from workers according to standard process and it will be possible after necessary standard operations to move, search, check, retrieve and collect from any remote or local storage system. So faulty filing is not possible and the possibility to uncontrolled document removal is greatly reduced such as the often-occurring need of mass memory increment needed to store the new amount of money.

A further advantage is that if an electronic label of radio frequency type is used very precise identification of document, boxes and envelopes could be realized identifying at any time that the overall documents contents of the store is present and tracing any document flows: in one embodiment of this invention on access, consulting and passages could be installed receiver/transmitter to check the box and/or document flows with high physical precision.

A further advantage is that in case of low energy directional signal emission and receiving from an electronic label of RF type is possible to reconstruct position of documents “as it is”, even after a disordered storage moving. If boxes with documents could be set in columns it is not needed a frame to support but only a lifting system to reach the lower position or nothing in case of front opening reducing the area preparation costs.

A further advantage is that in case the receiving and transmitting means is portable a worker could walk near the boxes etc. and having the function of identifying the searched one by the device without reading anything but inputting the requested identifier only and reducing overload and errors. In an embodiment of the present invention a narrow ray of required RF scans the area and reconstructs the position of any document box and envelope based on the relative movement of the emitter receiver that indicates direction of documents. It is possible thus with simple geometric calculation to assign absolute position of documents.

A further advantage is that if an important document such as stocks deposition, judicial cats etc. have to be secured and checked for integrity. There is the possibility to use an envelope in which the RF circuit and the memory are electrically connected to the sealed enclosure. The envelope and or document could be checked by emitter/transmitter for presence in a certain area for example every second assuring document presence. The envelope guarantees electrical continuity to memory and or RF circuit with a distributed fragile wiring embedded in envelope or simply using conductive envelope capacity to characterize the RF circuit. Any manipulation of the envelope produces a variation or modification of signal that is registered and use to start a checking procedure.

A further advantage is that it is possible to move a document and a box from a store to a different store and connect it wireless or via cable to the existing box network. The new store system identifies this new entry and automatically could update the local position and geographical position of the box and documents. This procedure is safe since a double check could be performed using RF signal fro documents and the contained memory. An other advantage of having a memory connected to the file box is that file box content could be searched simple connecting a reading and browsing device directly to the box allowing check of contents without reading every documents which presence is guaranteed by the RF tag.

### SUMMARY OF THE INVENTION

Modern society demands knowledge work that is appropriate for the information age. The requirements are that: relatively low paying manual work like filing paper documents must be phased out; and relatively high paying knowledge work like processing electronic documents must be phased in. The present invention is based on the insight that there is a necessary interaction between minimizing the inherent inefficiency of paper documents, and maximizing the inherent efficiency of electronic images, and moreover the necessity to transform and use the images of stored documents in text, formulas and symbols to increase knowledge contents. This demands also the need for as the documents are stored and not in advance since the cost of memory is lowering but it come with ownership costs much higher than hardware costs. The cost of loosing critical knowledge are enormous thus the system take care also of this aspect of document preservation guaranteeing a security level added to stored documents.

The primary object of the present invention is an apparatus for managing documents comprising a device for acquiring at least one image of a document means for storing said at least one image and/or at least information extracted from image analysis means for associating a label to said documents, said label comprising first information regarding the documents means for retrieving at least part of said information of said label wherein said label is an electronic label.

The primary object of the present invention is also a method Method for managing documents comprising the steps of: acquiring at least one image of a document, storing said at least one image, associating a label to a document, said label comprising first information regarding the documents retrieving at least part of said information of said label wherein said label is an electronic label.

An object of the present invention is to provide, for the storage, checking, searching and retrieval of documentary papers and corresponding digital means: an apparatus and processes that is based of intelligent file boxes distributed in storage building on shelters. The results of the use of such systems is a more satisfactory and less restrictive procedure in filing for employee while preserving consistency, exactness and control on the documentary storage process. Pursuant to the present invention, (1) newly received or generated documents simply are tagged—automatically or manually—as they come in random order, (2) image is captured, processed and an amount of data is created, (3) the physical documents are added to a file box connected physically—or via wireless—and contextually the radio frequency tag is programmed, the above mentioned data amount is saved in the memory on board the file box. (4) When the file box is filled out it is closed and the radio frequency identifier is automatically programmed or labelled. The result is a procedure highly transparent to the worker that requires less low-level interactions and reduces boring and repetitive operation of data input and checking.

A more specific object of the present invention is to provide a document storage, checking and retrieval system comprising a physical system for filing a sequence of paper documents, a tagging means to attach a tag to the document, an image capturing device for converting the documents as a suitable image, a system able to convert image to digital contents, and an electronic and physical system for storing digital means and the document itself. (a) The physical system includes a file boxes and a series of repositories. (b) The electronic system presents a series of file box including memory means, communication means—wireless or wired—, signaling means—radio frequency or label—, transmitting/receiving units, a distributed application able to search, check, and query the file box memory, the file box signal or label and the document signal or label.

### BRIEF DESCRIPTION OF THE DRAWINGS

For a fuller understanding of the nature and objects of the present invention, reference is made to the following specification, which is to be taken in connection with the accompanying drawings wherein:

FIG. 1 illustrates a system embodying the present invention;

FIG.2 illustrates a physical document having radio frequency identifier tag or label on it;

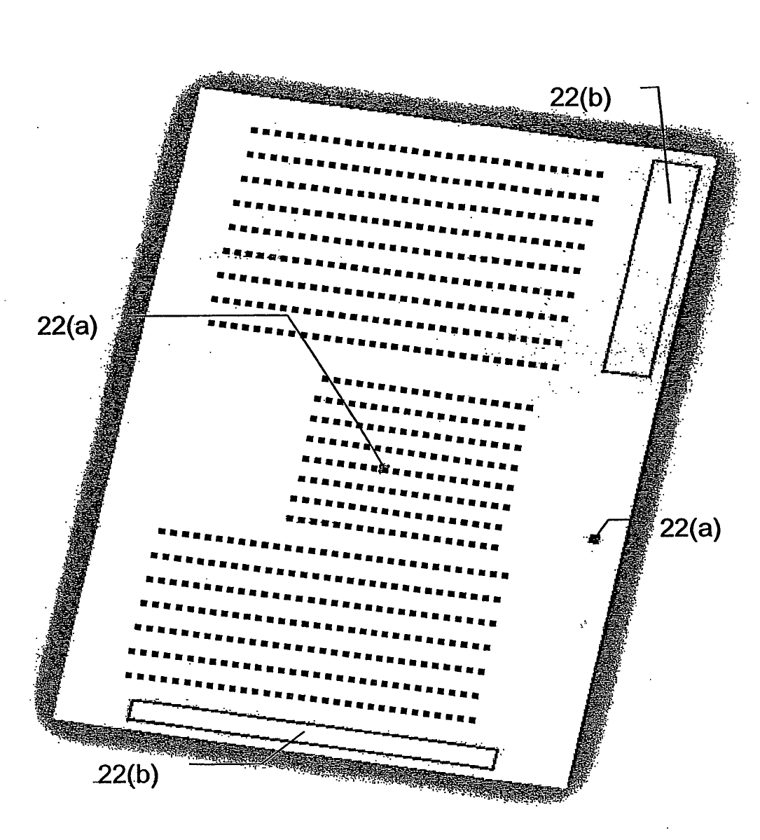

FIG. 3 illustrates a physical file box having memory unit, radio frequency identifier tag or label and a wireless communication unit;

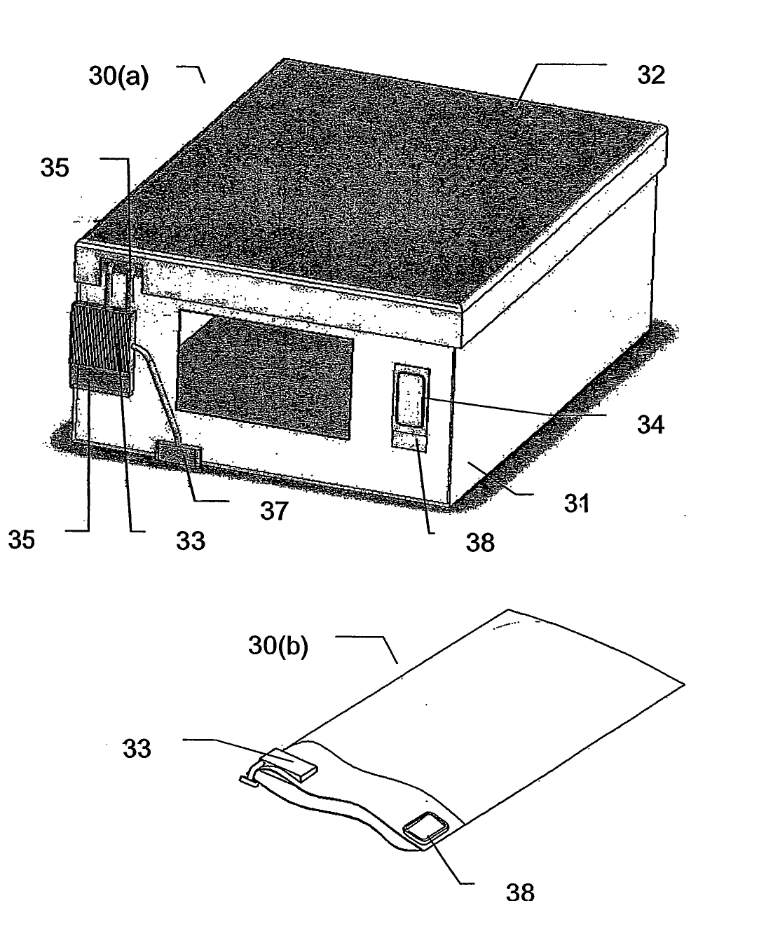

FIG. 4 illustrates a typical storage shelf

### DETAILED DESCRIPTION OF THE PREFERRED EMBODIMENT

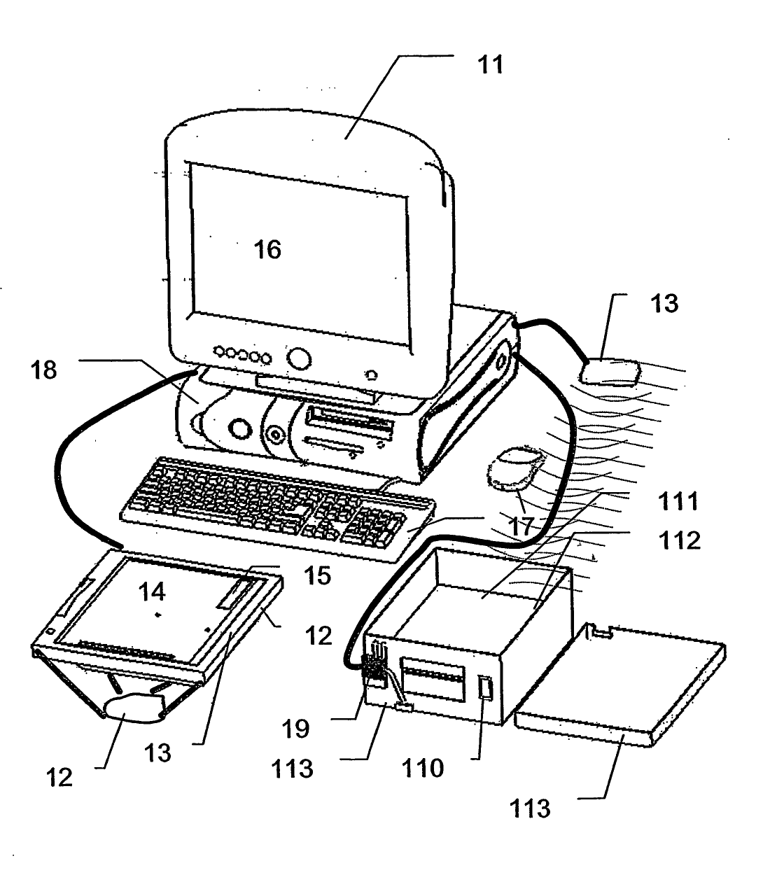

The present system is illustrated in FIG. 1. A computer 11 is connected to an acquisition device 13, on the acquisition device is placed a document 14. The document 14 is tagged in position 15; the tag 15 could be a radio frequency device or a label. System 12 is image-capturing devices. The computer 11 contains a processing unit to operate application and to show information on screen 16 and an input means 17 such as keyboard and mouse. A wireless receiving and transmitting device 18 is locally or remotely connected to the computer 11 to perform further operations such as RFID programming, searching, etc. One of the file box 113 described in details hereafter is connected locally or remotely to the computer 11. The box contains processed documents 111 with already programmed radio frequency identifier 112 or already processed label.

Original paper document 21 as is indifferently labelled or tagged before or after scanning. A tag 22 is preferable since it occupies small area compared to a label that should be read by optical devices of low cost. A RFID 22 is also preferable due to the capability of signaling back and for to it without optical ray projection. Preferable are for labelling are margins but in case of RFID is possible to label within the written area due to tag minimal occupied area. In any case the tag both if label and if RFID could be of simplest type returning a fixed univocal signal or of programmable type; in the last case for more safety the file box tag code is programmed in the RFID of the document in addition to document identifier.

The file box is the apparatus object of this invention and is constructed of any material able to contain documents, natural or artificial substances like paper, celluloid, plastic or even Fiberglass or metal. It could be shaped like an envelope for flat or tight shelf storage or in boxes for putting in piles forming an interconnecting shelf like array (as described hereafter). The file box has a main frame 31 and a cover or closure 32. The closure 32 and the frame 31 should be or coated of conductive material except on one side thus producing the function of transmitting and receiving through this side RF signals but not through other sides. Existing painting or plastic materials are cheap and reliable for this purpose. The closure 32 and frame 31 could form in closed condition a conductive pattern 35 used directly or through the other devices to check file box closure. On at least one side of this file box or inside is connected the memory module 33 preferably of flash memory type. Actual capacity and cost in quantity allow the production of such a file box with cost comparable to quality file box of traditional type. The memory unit could be connected to external devices wireless through a RF device, in this case as example a bluetooth module could be attached and connected to the memory module or through an electrical or optical connection. In any case the advantage of this type of wired connection is to have a further physical link to augment the security of the system. The memory system could have optionally a wired plug 37 in order to create a cascade of file boxes. The use of this wired configuration is especially useful in case of low cost storage when shelves or structures are not used to reduce immobilized material or for temporary or frequent moving storages. On at least one side of the file box a RFID 34 could be present it is preferably of the programmable type to store information such as the number of contained document and their identification. One of the preferred embodiments for the signal exchange is the resulting in signal subtraction from all the returned contained document signal f(Rd) and the returned signal from such RFID (or label reading) f(RFID) being zero. This means the operation f(RFID)−f(Rd)=0 guarantees the presence and integrity of contained documents.

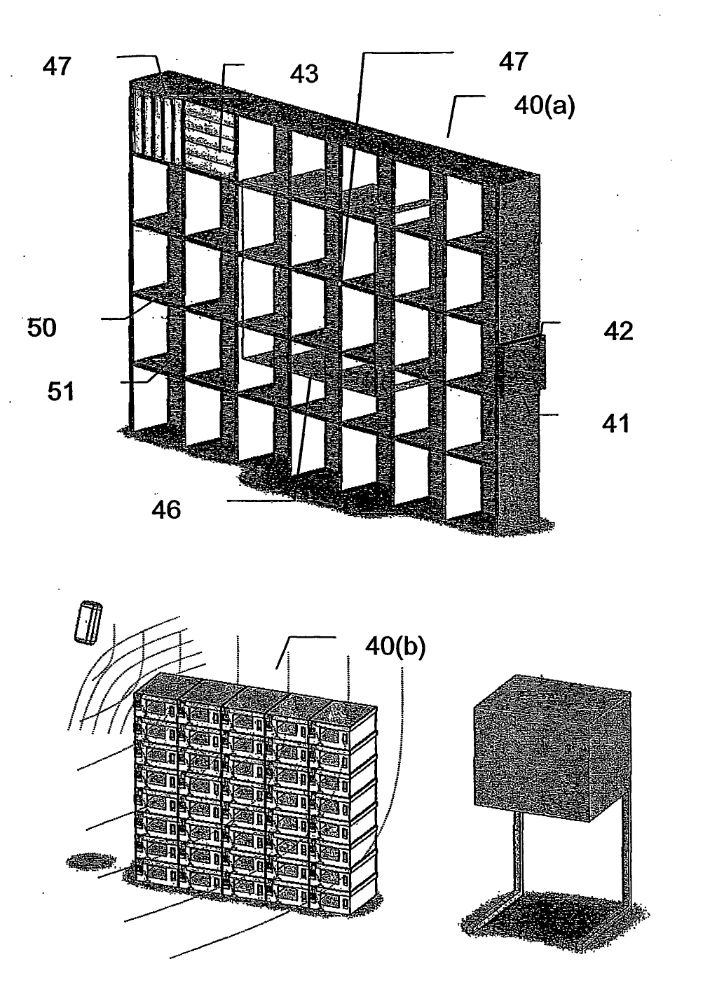

File boxes are 30 are stored together in a storage area as depicted in FIG. 4. The storage area could be a shelf or structure free. This depends mainly from the structural characteristics of the file box. In case of traditional storage environment a series of shelves 45 are present and the file boxes are stored on supporting surfaces with vertical frames. The characteristics of these components could be chosen to create cells or RF traps through the use of continuous metallic dividers or the structure of file box could create the same effect. This way of storing allows reducing costs of managing the store at central storing unit 42 connected to external resource or network 41 since it segments the system if easy to manage file box subsets. Since a standard configuration of minimal costs do not exceed 256 to 1024 file boxes both for usb connection type and for bluetooth this way of operation is useful it having overall system costs. File box could be connected in cascade or in parallel trough plug 37 and patches or being connected wireless with a cell transceiver 47 that could be at least the main unit 42.

### OPERATION

Pursuant to the present invention, the operation is according to following description.

Document Operation

(1) Newly received or generated documents simply are scanned,
(2) File box memory occupation, weight and space are checked if it is possible to store documents.
(3) Tag or label are attached, label and tags are preferably of the self-disruptive type so that any attempt of detaching, manumitting leaves traces on documents and destroy label or RFID circuitry. Document label take trace of the file box to which the document is assigned.
(4) Physical documents are added to the file box and the file box label and or RFID signal characteristics are newly calculated. Image and/or digital contents of the file are loaded in the file box memory.
   File Box Filing Operation
(5) A file box is chosen and connected to computer via cable or wireless,
(6) Memory, weight and condition of new file box are checked,
(7) For every new document stored in the box, its electronic image and means are added in the memory and the checksum part of the label or code calculated
(8) When file box is filled with documents the box label is printed or the RFID is programmed and the file box is closed and sent to storage
(9) If the memory is full and there is space left it is operator judge to add a memory expansion 35 or to close the file box.
(10) The file box reaches the store and is put in position, if it is of the plug type it is plugged.
(11) Central unit 42 senses modification to the configuration and ad to the list of present file boxes the one just inserted allowing access and consultation of file box memory through the network connection using standard or special designed application.
   Document Searching and Retrieving
(12) Using a client browsing and searching tool on the network or from central unit 42 is possible to find relevant documents directly if it known its unique serial or by searching it digital means via keywords, concepts, serial number directly querying the memory in all the storage file boxes memory unit.
(13) Once the document is found it is known the file box identifier since it is encoded in the RFID or in the label and in the file box memory,
(14) The file box is disconnected in case of wired type, open and the document is retrieved all this operations are under control via the central unit 42 that have also surveillance meaning.

An important point is that if a document is removed and label or RFID is removed from it, the information of tag is known constituting a deterrent, analogously being the tag a single use one it is not possible to remove it and apply to a falsified document.

In a special case it is possible to use transparent plastic single sheet envelopes guaranteeing the possibility to read the document while not opening the single envelope file box: this configuration is of maximum security type useful in law field and financial transaction basic documents such as main contracts. The main characteristic is that once sealed any trial to open the envelope produce invalidating procedure.

1. Apparatus for managing documents comprising:
a device for acquiring at least one image of a document;
means for storing said at least one image and/or at least information extracted from image analysis
means for associating a label to said documents, said label comprising first information regarding the documents; and
means for retrieving at least part of said information of said label;
wherein said label is an electronic label.

2. Apparatus for managing documents according to claim 1, wherein said electronic label is a transmitting and/or receiving unit.

3. Apparatus for managing documents according to claim 1, wherein said electronic label is a RF tag.

4. Apparatus for managing documents according to claim 1, further comprising a box for containing at least one document.

5. Apparatus for managing documents according to claim 4 further comprising an electronic label associated to said box.

6. Apparatus for managing documents according to claim 4, wherein said electronic label associated to said box comprises second information regarding the box and the at least one document contained in said box.

7. Apparatus for managing documents according to claim 1, wherein said means for retrieving at least part of said information of said label comprises an electronic information reader and means for performing a logical operation concerning said information.

8. Apparatus for managing documents according to claim 4, wherein said box further comprises a memory for storing data.

9. Apparatus for managing documents according to claim 4, further comprising means for searching and/or retrieving document contents by querying information of the box memory

10. Apparatus for managing documents according to claim 1, wherein said first information is box identifier and/or box position.

11. Apparatus for managing documents according to claim 1, wherein said first information is box position.

12. Apparatus for managing documents according to claim 1, wherein said information is the number of documents contained in said box.

13. Apparatus for managing documents according to claim 7, wherein said logical operation comprises the steps of:
retrieving first information from each document in order to have a first number associated to the count of the documents;
retrieving second information from the box regarding the number of documents contained inside; and
applying the difference between said first number and the number of documents retrieved from the second information.

14. Method for managing documents comprising the steps of:
acquiring at least one image of a document;
storing said at least one image;
associating a label to a document, said label comprising first information regarding the documents; and
retrieving at least part of said information of said label;
wherein said label is an electronic label.

15. Method for managing documents according to claim 13, further comprising the steps of:
processing document extracting digital text;
retrieving at least part of said information of said text corresponding to specified text;
retrieving the label of all the document connected to said text; and
retrieving the box identifier and/or position of all the boxes connected to said text.

16. Method for managing documents according to claim 13, further comprising the steps of:
storing said at least one document in an enclosure;
associating a label to the enclosure, said label having its physical characteristics connected to the integrity of enclosure; and
retrieving, frequently in time, at least part of said information of said label.

17. Method for managing documents according to claim 15, further comprising the steps of:
moving the enclosure in a storage area;
checking with a receiving transmitting means the presence of new labels; and
updating a reference system for modification.

18. Method for managing documents according to claim 15, further comprising the steps of:
processing document extracting digital text; and
storing said at least digital text in a memory located on the enclosure.

19. Method for managing documents comprising the steps of:
scanning an area with an emitter/receiver;
storing information of ray orientation and received signal; and
elaborating the stored information associating a label to said digital text;
wherein a physical position map is generated for documents and/or box.
